(19) United States
(12) Patent Application Publication
(10) Pub. No.: US 2025/0318507 A1
(43) Pub. Date: Oct. 16, 2025

(54) SMART INSECT CONTROL DEVICE VIA ARTIFICIAL INTELLIGENCE IN REAL TIME

(71) Applicant: BOARD OF TRUSTEES OF THE UNIVERSITY OF ARKANSAS, Fayetteville, AR (US)

(72) Inventors: Khoa Luu, Fayetteville, AR (US); Thanh-Dat Truong, Fayetteville, AR (US); Ashley Dowling, Fayetteville, AR (US)

(73) Assignee: BOARD OF TRUSTEES OF THE UNIVERSITY OF ARKANSAS, Fayetteville, AR (US)

(21) Appl. No.: 18/863,467

(22) PCT Filed: May 8, 2023
(86) PCT No.: PCT/US2023/021307

§ 371 Date: Nov. 6, 2024

Related U.S. Application Data
(60) Provisional application No. 63/339,013, filed on May 6, 2022.

(51) Int. Cl. A01K 29/00; A01M 1/02; G06F 18/241; G06N 3/0464; G06N 3/088

(52) U.S. Cl. CPC A01K 29/005; A01M 1/026; G06F 18/241; G06N 3/0464; G06N 3/088

(57) ABSTRACT

Embodiments of the present disclosure pertain to a computer-implemented method of insect control that includes: training a source model and a classifier on a source dataset in a source domain; adapting knowledge learned on the source domain to a target domain via unsupervised domain adaptive training; and deploying a model in the target domain in response to the adapting. The unsupervised adaptive training includes: projecting features that are on at least two domains into one-dimensional space; computing a plurality of Gromov-Wasserstein distances on the one-dimensional space; and determining a sliced Gromov-Wasserstein distance based at least partly on an average of the plurality of Gromov-Wasserstein distances. Additional embodiments pertain to a system for insect control, where the system includes a computing device with programming instructions for implementing the method.

### CROSS-REFERENCE TO RELATED APPLICATIONS

The present application claims the benefit of U.S. Provisional Patent Application No. 63/339,013, filed on May 6. 2022. The entirety of the aforementioned application is incorporated herein by reference.

### BACKGROUND

With the development of technology. farmers are more frequently turning to high technology (e.g., precision agriculture) to better manage crops and reduce costs. Crop management involves careful control of soil chemistry, water availability, plant spacing, weeds, and insect pests. Despite technological improvements in recent years, monitoring insect pests remains one of the most manually intensive aspects of crop management.

### SUMMARY

In some embodiments, the present disclosure pertains to a computer-implemented method of insect control. In some embodiments, the method includes: training a source model and a classifier on a source dataset in a source domain; adapting knowledge learned on the source domain to a target domain via unsupervised domain adaptive training; and deploying a model in the target domain in response to the adapting. In some embodiments, the unsupervised adaptive training includes: projecting features that are on at least two domains into one-dimensional space; computing a plurality of Gromov-Wasserstein distances on the one-dimensional space; and determining a sliced Gromov-Wasserstein distance based at least partly on an average of the plurality of Gromov-Wasserstein distances.

Additional embodiments of the present disclosure pertain to a system for insect control. In some embodiments, the system includes a computing device. In some embodiments, the computing device includes one or more computer readable storage mediums having at least one program code embodied therewith. In some embodiments, the at least one program code includes programming instructions for: training a source model and a classifier on a source dataset in a source domain; adapting knowledge learned on the source domain to a target domain via unsupervised domain adaptive training; and deploying a model in the target domain in response to the adapting. In some embodiments, the programming instructions for the unsupervised adaptive training also includes programming instructions for: projecting features that are on at least two domains into one-dimensional space; computing a plurality of Gromov-Wasserstein distances on the one-dimensional space; and determining a sliced Gromov-Wasserstein distance based at least partly on an average of the plurality of Gromov-Wasserstein distances.

### BRIEF DESCRIPTION OF THE DRAWINGS

FIG. 1A illustrates a computer-implemented method of insect control in accordance with various embodiments of the present disclosure.

FIG. 1B illustrates an example of a computing device for insect control in accordance with various embodiments of the present disclosure.

FIG. 2 illustrates an example of a sliced Gromov-Wasserstein distance.

FIGS. 3A-3C illustrate an example of a training process.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

With many farms consisting of thousands of acres, manually counting and identifying insects is not feasible. Despite the many advances in precision agriculture, insect management is one area that is still largely reliant on manual labor.

Insect-related disasters are one of the most important factors affecting crop yield due to the fast reproduction, widely distributed, and large variety of insects. In the agricultural revolution, detecting and recognizing insects plays an important role in the ability for crops to grow healthily and produce a high-quality yield. To achieve this, insect recognition helps to differentiate between bugs that must be targeted for pest control and bugs that are essential for protecting farms. While the kinds of insects are broad and available insect datasets have been collected from different sources, the existing insect recognition models are trained on a specific dataset with particular, predefined insects.

For example, one approach, domain adaptation, is a technique in machine learning. especially convolutional neural networks (CNN), that functions by learning a concept from a source dataset and performing well on target datasets. The main aim of domain adaptation is to learn a distribution in the source data and find a way to improve the performance of a model on a different target data distribution.

Domain adaptation seeks to reduce the domain shift happening between the source and the target domain. Deep convolution networks used in segmentation, classification, and recognition of visual domains in many applications operate by learning good features from the given datasets. Moreover, the learned representation from the deep convolution networks is used for other datasets.

However, these domain adaptation representations may not generalize enough for the new datasets due to the domain shift. It is possible to mitigate this problem by fine-tuning. However, for large parameters employed by deep multi-layer networks, it is challenging to acquire ample labeled data. The main goal of the domain adaptation is to reduce the discrepancy between the source and the target feature distributions by leading feature learning.

As a further example, another approach, optimal transport, has been widely used to compute the distance between two probability distributions, which has been first introduced in middle of the 19th century. Optimal transport has several applications in image processing (e.g., color transfer between images) and computer graphics (e.g., shape matching).

Recently, optimal transport has gained much attention from the computer vision research society. Optimal transport has become a major metric in learning generative models and domain adaptations. However, optimal transport suffers from several issues, specifically, the computation efficiency. Computing the optimal transport distances (e.g., Wasserstein and Gromov-Wasserstein) generally requires a large computational cost since it has to solve the assignment problems which are NP hard problem in the general cases.

Thus, the previous approaches on insect recognition are unable to recognize new types of insects from other datasets as well as utilize the knowledge from different datasets. Machine learning, especially deep learning, typically requires a large volume of data to achieve high performance. Hence, transferring and utilizing knowledge from various datasets is desirable.

In sum, a need exists for improved systems and methods to identify and count insect species in real-time. Moreover, a highly adaptable insect trapping system that can automatically identify and count a broad diversity of insects would serve an unmet need in precision agriculture. Numerous embodiments of the present disclosure aim to address the aforementioned needs.

### Computer-Implemented Method of Insect Control

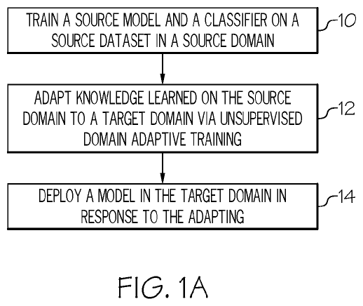

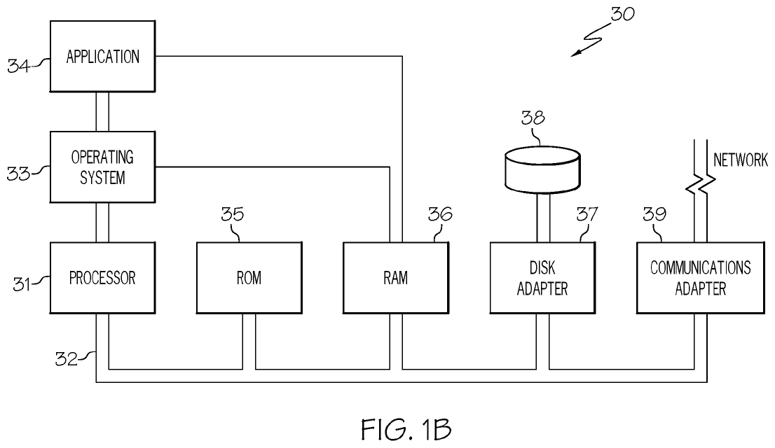

In some embodiments, the present disclosure pertains to a computer-implemented method of insect control. In some embodiments illustrated in FIG. 1A, the method includes: training a source model and a classifier on a source dataset in a source domain (step 10); adapting knowledge learned on the source domain to a target domain via unsupervised domain adaptive training (step 12); and deploying a model in the target domain in response to the adapting (step 14). As set forth in more detail herein, the method of the present disclosure can have numerous embodiments.

### Classifiers

The method of the present disclosure may train various types of classifiers. For instance, in some embodiments, the classifier includes an insect classifier. In some embodiments, the classifier is a machine learning algorithm. In some embodiments, the machine-learning algorithm is an L1-regularized logistic regression algorithm. In some embodiments, the machine-learning algorithm includes supervised learning algorithms. In some embodiments, the supervised learning algorithms include nearest neighbor algorithms, naïve-Bayes algorithms, decision tree algorithms, linear regression algorithms, support vector machines, neural networks, convolutional neural networks. ensembles (e.g., random forests and gradient boosted decision trees), and combinations thereof.

In some embodiments, the classifier is a convolutional neural network (CNN) algorithm. In some embodiments, CNN algorithm includes, without limitation, Region-based CNN (R-CNN) algorithms, Fast R-CNN algorithms, rotated CNN algorithms, mask CNN algorithms, and combinations thereof.

### Source Models

The method of the present disclosure may train various types of source models. For instance, in some embodiments, the source model includes an artificial intelligence (AI) model. In some embodiments, the AI model includes a machine learning model. In some embodiments, the AI model includes a deep learning model to extract information from collected insect data. In some embodiments, the source model is designed for optimized performance on insect data and software deployments.

### Source Datasets and Source Domains

The method of the present disclosure may train source models and classifiers on various source datasets in various source domains. In some embodiments, the source domain includes data distribution from the source dataset on which the source model is trained. In some embodiments, a source model may be operational to handle multiple types of data distribution. In some embodiments, the data distributions could be varied from images (e.g., insect images) collected in a well-controlled environment (e.g., a laboratory) to images (e.g., insect images) collected in the wild. In some embodiments, the data distribution could be varied for different families of insects (e.g., the Saturniidae family, the Apoidea family, and other families).

In some embodiments, the source dataset includes labeled data. In some embodiments, the source dataset includes insect-related data. In some embodiments, the insect-related data includes data on pre-defined insects. In some embodiments, the insect-related data include data on different types of insects. In some embodiments, the different types of insects include population-level variations of insects. In some embodiments, the different types of insects include different genders of insects. In some embodiments, the different types of insects include different species of insects. In some embodiments, the species of insects include various insect families and genres varied from useful insects (e.g., honeybees, praying mantises, green lacewings, dragonflies, earthworms, and others) to insect pests (e.g., cotton bollworm, tobacco whitefly, diamondback moth, and others).

Source datasets may be in various forms. For instance, in some embodiments, the source dataset may be in the form of images. In some embodiments, the source dataset includes images of different types of insects. In some embodiments, the source dataset includes meta information. In some embodiments, the meta information includes labels of insects. In some embodiments, the labels of insects include the name of insects, the family name of insects, the genre name of insects, or combinations thereof.

Various methods may be utilized to train a source model and a classifier on a source dataset. For instance, in some embodiments, a classifier (i.e., a machine learning algorithm) is used to build and train the source model to count and identify insects in real time based on a source dataset (e.g., images of different types of insects). In one embodiment, such a source model is built and trained using a sample dataset that includes the source datasets (e.g., images of different types of insects). In one embodiment, such a sample dataset is compiled by an expert.

Furthermore, such a sample data set is referred to herein as the “training data,” which is used by the classifier (i.e., a machine learning algorithm) to make predictions or decisions as to the estimated identity and number of insects. The algorithm iteratively makes predictions of the estimated identity and number of insects until the predictions achieve the desired accuracy as determined by an expert.

In some embodiments, a source model is optimized with the labels of a source dataset. In particular embodiments, a source model produces the predictions from the images, followed by penalizing the correctness of predictions by the learning objective. Then, the source model is learned and updated by the Stochastic Gradient Descent.

### Adapting Knowledge Learned on the Source Domain to a Target Domain

Various methods may be utilized to adapt knowledge learned on a source domain to a target domain. In some embodiments. the target domain includes data distribution on which the source model pre-trained on the source dataset in the source domain is used to perform a similar task. In some embodiments, the target domain includes unlabeled data. In some embodiments, the unlabeled data includes images of various types of insects. In some embodiments, the images of insects are collected from multiple sources (e.g., the laboratory, a well-controlled farm, in the wild, or combinations thereof).

In some embodiments, the unsupervised adaptive training includes training a model on labeled data from the source domain to achieve better performance on data from the target domain with access to only unlabeled data in the target domain. In some embodiments, the unsupervised adaptive training includes: projecting features that are on at least two domains into one-dimensional space; computing a plurality of Gromov-Wasserstein distances on the one-dimensional space; and determining a sliced Gromov-Wasserstein distance based at least partly on an average of the plurality of Gromov-Wasserstein distances.

In some embodiments, the determined Gromov-Wasserstein distance aligns and associates features between the source domain and the target domain. In some embodiments, the alignment reduces topological differences of feature distributions between the source domain and the target domain. In particular embodiments, a source model (e.g., a machine learning model) first produces high-dimensional features of source and target domains. Then, the high-dimensional features are projected to a one-dimensional (1-D) space by multiple projection matrices to compute the 1-D Gromov-Wasserstein distances. The final distance is computed by averaging the 1D Gromov-Wasserstein distances. This distance is considered as a learning objective and used to optimize a source model (e.g., a machine learning model).

### Deployed Models

The method of the present disclosure may be utilized to deploy various types of models. For instance, in some embodiments, the model is operable to manually count and identify insects in real time. In some embodiments, the model is operable to utilize knowledge from different datasets. In some embodiments, the model is operable to differentiate between different types of insects. In some embodiments, the model is operable to differentiate between insects to be eliminated and insects to be preserved. In some embodiments, the model is operable to recognize new types of insects that were not part of a source dataset. In some embodiments, the new types of insects include new population-level variations of insects. In some embodiments, the new types of insects include new species of insects. In some embodiments, the model is able to identify and gather the insects of the same species into the same group. In some embodiments, the model is implemented and optimized to perform on the edge device deployed in the farm.

### System for Insect Control

Additional embodiments of the present disclosure pertain to a system for insect control. In some embodiments, the system includes a computing device. In some embodiments, the computing device includes one or more computer readable storage mediums having at least one program code embodied therewith. In some embodiments, the at least one program code includes programming instructions for: training a source model and a classifier on a source dataset in a source domain; adapting knowledge learned on the source domain to a target domain via unsupervised domain adaptive training; and deploying a model in the target domain in response to the adapting.

In some embodiments, the programming instructions for the unsupervised adaptive training also includes programming instructions for: projecting features that are on at least two domains into one-dimensional space; computing a plurality of Gromov-Wasserstein distances on the one-dimensional space; and determining a sliced Gromov-Wasserstein distance based at least partly on an average of the plurality of Gromov-Wasserstein distances. In some embodiments, the determined Gromov-Wasserstein distance aligns and associates features between the source domain and the target domain. In some embodiments, the alignment reduces topological differences of feature distributions between the source domain and the target domain.

In some embodiments, the programming instructions for the unsupervised adaptive training further includes programming instructions for training a model on labeled data from the source domain to achieve better performance on data from the target domain with access to only unlabeled data in the target domain.

In some embodiments, the classifier is a machine learning algorithm. In some embodiments, the machine learning algorithm includes a convolutional neural network (CNN) algorithm. In some embodiments, CNN algorithm includes, without limitation, Region-based CNN (R-CNN) algorithms, Fast R-CNN algorithms, rotated CNN algorithms, mask CNN algorithms, and combinations thereof. In some embodiments, the classifier includes an insect classifier.

In some embodiments, the source model includes an artificial intelligence model. In some embodiments, the source dataset includes labeled data. In some embodiments, the source dataset includes insect-related data. In some embodiments, the insect-related data include data on pre-defined insects. In some embodiments, the insect-related data include data on different types of insects. In some embodiments, the different types of insects include population-level variations of insects. In some embodiments, the different types of insects include different species of insects.

In some embodiments, the source domain includes data distribution from the source dataset on which the model is trained. In some embodiments, the target domain includes data distribution on which the source model pre-trained on the source dataset in the source domain is used to perform a similar task.

In some embodiments, the model is operable to manually count and identify insects in real time. In some embodiments, the model is operable to differentiate between different types of insects. In some embodiments, the model is operable to differentiate between insects to be eliminated and insects to be preserved. In some embodiments, the model is operable to recognize new types of insects that were not part of the source dataset. In some embodiments, the new types of insects include new population-level variations of insects. In some embodiments, the new types of insects include new species of insects.

The computing devices of the present disclosure can include various types of computer readable storage mediums. For instance, in some embodiments, the computer readable storage mediums can be a tangible device that can retain and store instructions for use by an instruction execution device. In some embodiments, the computer readable storage medium may include, without limitation. an electronic storage device, a magnetic storage device, an optical storage device, an electromagnetic storage device, a semiconductor storage device, or combinations thereof. A non-exhaustive list of more specific examples of suitable computer readable storage medium includes, without limitation, a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, or combinations thereof.

A computer readable storage medium, as used herein, is not to be construed as being transitory signals per se. Such transitory signals may be represented by radio waves or other freely propagating electromagnetic waves, electromagnetic waves propagating through a waveguide or other transmission media (e.g., light pulses passing through a fiber-optic cable), or electrical signals transmitted through a wire.

In some embodiments, computer readable program instructions described herein can be downloaded to respective computing/processing devices from a computer readable storage medium or to an external computer or external storage device via a network, such as the Internet, a local area network, a wide area network and/or a wireless network. In some embodiments, the network may include copper transmission cables, optical transmission fibers, wireless transmission, routers, firewalls, switches, gateway computers and/or edge servers. In some embodiments, a network adapter card or network interface in each computing/processing device receives computer readable program instructions from the network and forwards the computer readable program instructions for storage in a computer readable storage medium within the respective computing/processing device.

In some embodiments, computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages.

In some embodiments, the computer readable program instructions may execute entirely on the user's computer, partly on the user's computer, as a stand-alone software package, partly on the user's computer and partly on a remote computer or entirely on the remote computer or server. In the latter scenario, the remote computer may be connected in some embodiments to the user's computer through any type of network, including a local area network (LAN) or a wide area network (WAN). or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present disclosure.

Embodiments of the present disclosure for insect control as discussed herein may be implemented using a computing device illustrated in FIG. 1B. Referring now to FIG. 1B, FIG. 1B illustrates an embodiment of the present disclosure of the hardware configuration of a computing device 30 which is representative of a hardware environment for practicing various embodiments of the present disclosure.

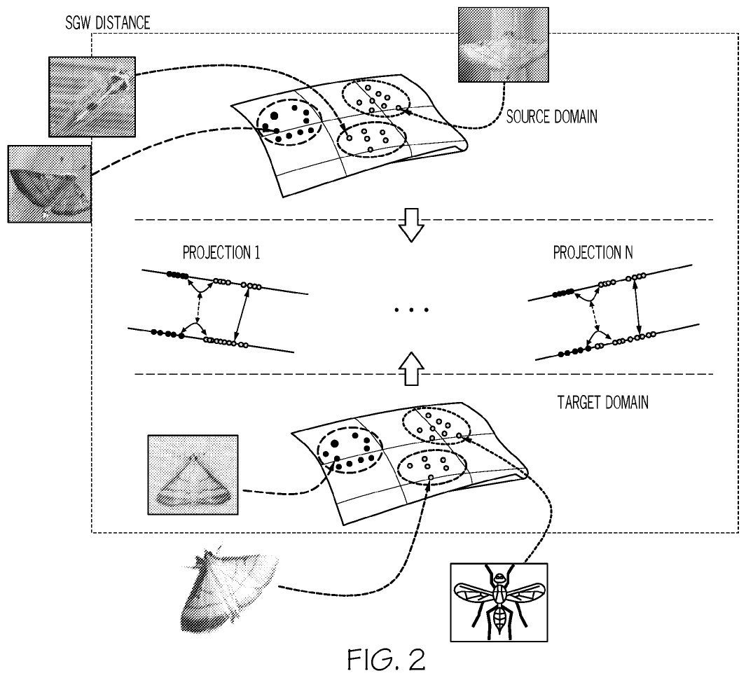

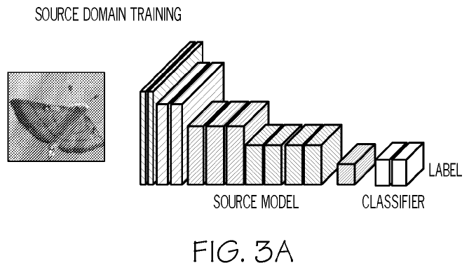

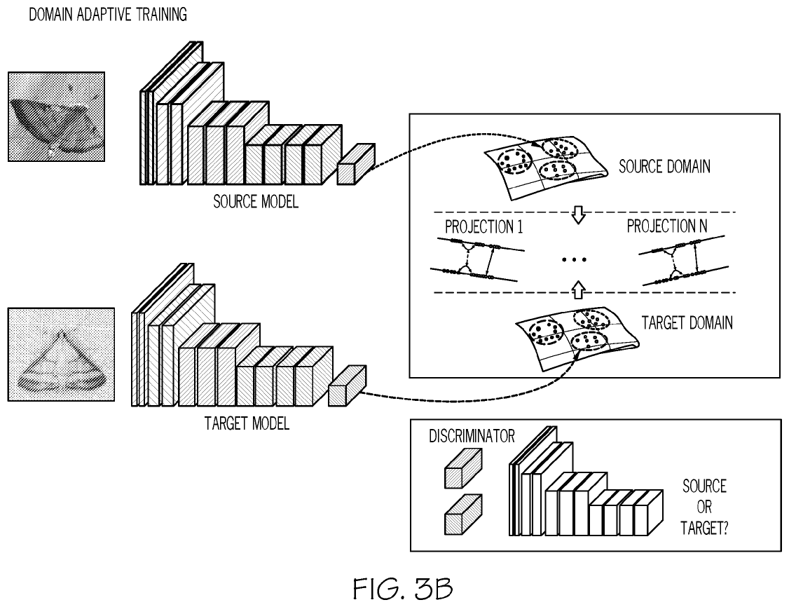

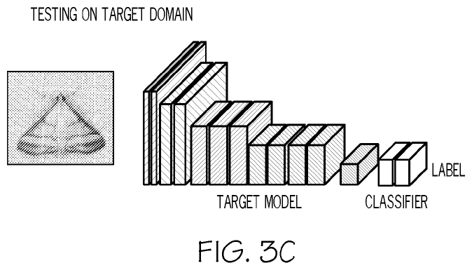

Computing device 30 has a processor 31 connected to various other components by system bus 32. An operating system 33 runs on processor 31 and provides control and coordinates the functions of the various components of FIG. 1B. An application 34 in accordance with the principles of the present disclosure runs in conjunction with operating system 33 and provides calls to operating system 33, where the calls implement the various functions or services to be performed by application 34. Application 34 may include, for example, a program for insect control as discussed in the present disclosure, such as in connection with FIGS. 2 and 3A-3C.

Referring again to FIG. 1B, read-only memory (“ROM”) 35 is connected to system bus 32 and includes a basic input/output system (“BIOS”) that controls certain basic functions of computing device 30. Random access memory (“RAM”) 36 and disk adapter 37 are also connected to system bus 32. It should be noted that software components including operating system 33 and application 34 may be loaded into RAM 36, which may be computing device's 30 main memory for execution. Disk adapter 37 may be an integrated drive electronics (“IDE”) adapter that communicates with a disk unit 38 (e.g., a disk drive). It is noted that the program for insect control, as discussed in the present disclosure, such as in connection with FIGS. 2 and 3A-3C, may reside in disk unit 38 or in application 34.

Computing device 30 may further include a communications adapter 39 connected to bus 32. Communications adapter 39 interconnects bus 32 with an outside network (e.g., wide area network) to communicate with other devices.

Aspects of the present invention are described herein with reference to flowchart illustrations and/or block diagrams of methods, apparatus (systems), and computing devices according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality. and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be accomplished as one step. executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Applications and Advantages

In various embodiments, the method and system of the present disclosure can achieve various advantages. For instance, in some embodiments, the system and method of the present disclosure can allow for highly adaptable detection and identification of insects found in agricultural settings. In some embodiments, the system and method of the present disclosure can continually learn new species. In some embodiments, the system and method of the present disclosure can recognize new population-level variations of species. In some embodiments. the system and method of the present disclosure can be optimized to different crops and regions of the world.

As such, the method and system of the present disclosure can have various applications. For instance, in some embodiments, the method and system of the present disclosure are applicable to multiple fields such as pest control and/or identifying bugs essential for protecting farms. More generally, the method and system of the present disclosure can be widely applicable in agriculture.

### Additional Embodiments

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Example 1. Smart Insect Control Device via Artificial Intelligence in Realtime Environment

This Example describes a new deep learning-based domain adaptation algorithm by utilizing sliced Gromov-Wasserstein distance. By minimizing the gap of distributions between different datasets, the proposed method can generalize well on the new target domains. In addition, this Example describes a hardware system for deploying the deep learning model, as a complete system, to run in real-world farms. Additionally, this Example describes deep learning approaches to train a robust insect classifier.

In addition, this Example presents a framework for unsupervised domain adaptation based on optimal transport-based distance to train the robust insect classifier. The framework introduces an optimal transport-based distance named Gromov-Wasserstein for unsupervised domain adaptation. The presented Gromov-Wasserstein distance can help to align and associate features between source and target domains. The alignment process can help to mitigate the topological differences of feature distributions between two different domains. This Example also presents a sliced approach to fast approximate the Gromov-Wasserstein distance.

This Example also utilizes recent advanced deep learning approaches to deal with limited training samples. In particular, Applicant presents a novel optimal transport loss approach to domain adaptation integrated into the deep CNN to train a robust insect classifier.

The most recent domain adaptation methods are based on adversarial training that minimizes the discrepancy between source and target domains. However, minimizing feature distributions in different domains is not practical due to the lack of a feasible metric across domains. Moreover, these current methods ignore the feature structures between source and target domains. To address these issues, this Example proposes a novel optimal transport distance, specifically, the Gromov-Wasserstein distance, that allows comparing features across domains while aligning feature distributions and maintaining the feature structures between source and target domains. In addition, since the computation of Gromov-Wasserstein distance is costly due to the solving non-convex quadratic assignment problem, this Example presents a fast approximation form of Gromov-Wasserstein distance based on 1D-Gromov-Wasserstein distance.

As shown in FIG. 2, the high dimensional features on two domains are projected into one-dimensional space. Then, the Gromov-Wasserstein distance on the 1D space is efficiently computed. Finally, the sliced Gromov-Wasserstein distance will be the average of the Gromov-Wasserstein distances on the 1D space via multiple projections.

As shown in FIGS. 3A-3C, the training process involves two main steps. First, the source model and the classifier are trained on source datasets (FIG. 3A). Then, the knowledge learned on the source domain is adapted to the target domain during domain adaptive training process (FIG. 3B). Finally, the final model is deployed into the target domain (FIG. 3C).

The final model can then be implemented into a Smart Insect Control Device. In particular, the images of insects captured from the camera are forwarded to the model. Then, the model detects and identifies the insects existed on the images. The results of identified insects will be informed to the users. The implementation of the developed model is also optimized to run on the edge device.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

1. A computer-implemented method of insect control, said method comprising:
training a source model and a classifier on a source dataset in a source domain;
adapting knowledge learned on the source domain to a target domain via unsupervised domain adaptive training, wherein the unsupervised adaptive training comprises:
projecting features that are on at least two domains into one-dimensional space;
computing a plurality of Gromov-Wasserstein distances on the one-dimensional space, and
determining a sliced Gromov-Wasserstein distance based at least partly on an average of the plurality of Gromov-Wasserstein distances; and
deploying a model in the target domain in response to the adapting.

2. The method of claim 1, wherein the classifier is a convolutional neural network (CNN) algorithm.

3. The method of claim 2, wherein the CNN algorithm is selected from the group consisting of Region-based CNN (R-CNN) algorithms, Fast R-CNN algorithms, rotated CNN algorithms, mask CNN algorithms, and combinations thereof.

4. The method of claim 1, wherein the classifier comprises an insect classifier.

5. The method of claim 1, wherein the source model comprises an artificial intelligence model.

6. The method of claim 1, wherein the source dataset comprises labeled data.

7. The method of claim 1, wherein the source dataset comprises insect-related data.

8. The method of claim 7, wherein the insect-related data comprise data on pre-defined insects.

9. The method of claim 8, wherein the insect-related data comprise data on different types of insects.

10. The method of claim 9, wherein the different types of insects comprise population-level variations of insects, different species of insects, or combinations thereof.

11. The method of claim 9, wherein the source dataset comprises images of the different types of insects.

12. The method of claim 1, wherein the source domain comprises data distribution from the source dataset on which the model is trained.

13. The method of claim 1, wherein the target domain comprises data distribution on which the source model pre-trained on the source dataset in the source domain is used to perform a similar task.

14. The method of claim 1, wherein the determined Gromov-Wasserstein distance aligns and associates features between the source domain and the target domain.

15. The method of claim 1, wherein the alignment reduces topological differences of feature distributions between the source domain and the target domain.

16. The method of claim 1, wherein the unsupervised adaptive training comprises training a model on labeled data from the source domain to achieve better performance on data from the target domain with access to only unlabeled data in the target domain.

17. The method of claim 1, wherein the model is operable to manually count and identify insects in real time.

18. The method of claim 1, wherein the model is operable to differentiate between different types of insects.

19. The method of claim 1, wherein the model is operable to differentiate between insects to be eliminated and insects to be preserved.

20. The method of claim 1, wherein the model is operable to recognize new types of insects that were not part of the source dataset.

21. The method of claim 1, wherein the new types of insects comprise new population-level variations of insects.

22. The method of claim 1, wherein the new types of insects comprise new species of insects.

23. A system for insect control, wherein the system comprises a computing device, wherein the computing device comprises one or more computer readable storage mediums having at least one program code embodied therewith, wherein the at least one program code comprises programming instructions for:
training a source model and a classifier on a source dataset in a source domain;
adapting knowledge learned on the source domain to a target domain via unsupervised domain adaptive training, wherein the programming instructions for the unsupervised adaptive training further comprises programming instructions for:
projecting features that are on at least two domains into one-dimensional space,
computing a plurality of Gromov-Wasserstein distances on the one-dimensional space, and
determining a sliced Gromov-Wasserstein distance based at least partly on an average of the plurality of Gromov-Wasserstein distances; and
responsive to the adapting, deploying a model in the target domain.

24. The system of claim 23, wherein the determined Gromov-Wasserstein distance aligns and associates features between the source domain and the target domain.

25. The system of claim 23, wherein the alignment reduces topological differences of feature distributions between the source domain and the target domain.

26. The system of claim 23, wherein the classifier is a convolutional neural network (CNN) algorithm.

27. The system of claim 26, wherein CNN algorithm is selected from the group consisting of Region-based CNN (R-CNN) algorithms, Fast R-CNN algorithms, rotated CNN algorithms, mask CNN algorithms, and combinations thereof.

28. The system of claim 23, wherein the classifier comprises an insect classifier.

29. The system of claim 23, wherein the source model comprises an artificial intelligence model.
